(19) United States
(12) Patent Application Publication
(10) Pub. No.: US 2015/0303628 A1
(43) Pub. Date: Oct. 22, 2015

(54) LIGHT-EMITTING UNIVERSAL SERIAL BUS SOCKET

(71) Applicant: OXERER TECHNOLOGIES CO., LTD., TAIPEI CITY (TW)

(72) Inventor: PO-CHIN HUANG, TAIPEI CITY 112 (TW)

(21) Appl. No.: 14/684,578

(22) Filed: Apr. 13, 2015

(30) Foreign Application Priority Data
Apr. 16, 2014 (TW) 103206647

(51) Int. Cl. H01R 13/717; H01R 12/72

(52) U.S. Cl. CPC H01R 13/7172; H01R 12/721; H01R 13/7175

(57) ABSTRACT

A light-emitting universal serial bus socket is provided. The structure comprises a housing, an electrical connection board, and a light-emitting unit. The electrical connection board is disposed in the housing. The electrical connection board is a light-guiding structure. In addition, the light-emitting unit is disposed on one side of the electrical connection board. The light-emitting unit emits light, which passes through the electrical connection board and light up. The universal serial bus socket according to the present invention has the light-emitting effect, which facilitates identifying plugs in nocturnal applications as well as enriching creativity.

### FIELD OF THE INVENTION

The present invention relates generally to a universal serial bus socket, and particularly to a light-emitting universal serial bus socket.

### BACKGROUND OF THE INVENTION

When multimedia computers were just presented to be public. the transmission interfaces to external devices differ. For example, printers could only be connected to the LPT port; modems could only be connected to RS232; mice and keyboards could only be connected to PS/2. Complicated interfacial systems and the requirements of installing driver programs and rebooting all brought inconvenience to users. Thereby, it has become an unavoidable trend to create a unified and supportive transmission interface for external devices.

In daily applications, the universal serial bus (USB) is serial bus standard for connecting a computer system to external devices. It is also a technical regulation most widely adopted for the input/output interfacing. Thanks to their ease of use, compact size, and reasonable cost, USBs are applied extensive in various scenarios. No matter domestic core entertainment devices such as TVs, notebook computers, smartphones, and tablet devices for personal usage, computers and printers in offices, or even multimedia communication and entertainment systems, people rely on USBs for data transmission.

In addition to convenient, rapid, and reliable data transmission, USBs also have a very convenient function of charging electronic devices by transmitting power via the interfaces of multimedia electronic devices.

Modern notebook computers all include a plurality of USB sockets for connecting with mice, portable hard disks, printers, and keyboards having USB plugs. As technologies advance, using conversion cables with USB plugs on both ends to connect electronic devices, for example, mobile phone, digital cameras, and personal digital assistants, to computers becomes popular. Besides, due to the design trend of compactness and lightness in electronic devices, the sizes of USB plugs and sockets are miniaturized accordingly.

Nonetheless, because the sizes of USB plugs and sockets become smaller, it frequently requires multiple trials before a user can insert a USB plug into a USB socket correctly. In particular, in the dim application environment, insertion of a USB plug into a USB socket might fail.

Accordingly, the present improves the above drawbacks according to the prior art and provides a light-emitting USB socket used for mating a USB plug. The USB socket according to the present invention includes a light-guiding structure. A light-emitting unit is further disposed for emitting light to pass through the light-guiding structure and thus enabling the USB socket to emit light. Thereby, the structure according to the present invention is an invention with nonobviousness and novelty.

### SUMMARY

An objective of the present invention is to provide a light-emitting USB socket, which emits light at the opening of the USB socket for enabling a USB plug to mate the USB socket accurately.

In order to achieve the objective and efficacy described above, the light-emitting USB socket according to the present invention is provided for a USB plug and comprises a housing, an electrical connection board, and a light-emitting unit. The housing includes an accommodating space and an opening communicating with the accommodating space. The electrical connection board is disposed in the accommodating space. A plurality of USB signal terminals are disposed on the electrical connection board and provided for connecting electrically with the USB plug. In addition, the electrical connection board is a light-guiding structure. Furthermore, the light-emitting unit is disposed on one side of the electrical connection board. The light-emitting unit emits light, which passes through the electrical connection board and illuminate towards the direction to the opening.

### BRIEF DESCRIPTION OF THE DRAWINGS

FIG. 1 shows a three-dimensional diagram of the light-emitting USB socket according to the first embodiment of the present invention;

FIG. 2 shows a cross-sectional view of the light-emitting USB socket according to the first embodiment of the present invention;

FIG. 3 shows a usage diagram of the light-emitting USB socket according to the first embodiment of the present invention; and

FIG. 4 shows a structural diagram of the object of the light-emitting USB socket according to the first embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides a light-emitting USB socket used for mating a USB plug. Due to the design trend of compactness and lightness in electronic devices, the sizes of USB plugs and sockets are miniaturized accordingly, which leads to difficulty in mating a USB socket with a USB plug. In particular, in the dim application environment, insertion of a USB plug into a USB socket tends to fail. The present invention is proposed for improving the drawback according to the prior art.

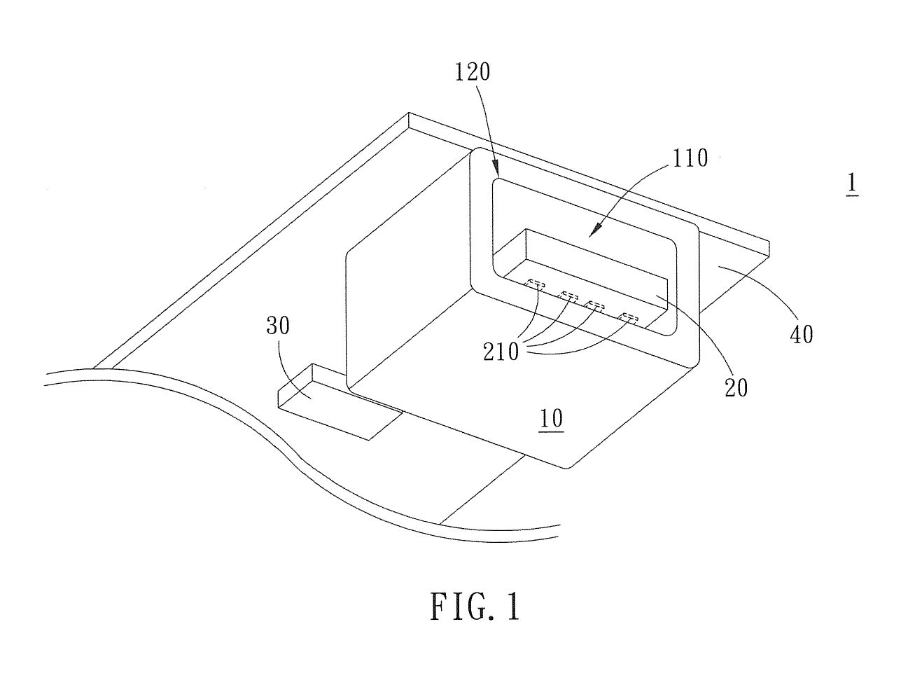

FIG. 1 shows a three-dimensional diagram of the light-emitting USB socket according to the first embodiment of the present invention. As shown in the figure, the light-emitting USB socket 1 according to the present invention is used for mating a USB plug 2 and mainly comprises a housing 10, an electrical connection board 20, and at least a light-emitting unit 30. The housing 10 has an accommodating space 110 and an opening 120. A plurality of USB signal terminals 210 are disposed on the electrical connection board 20. In addition, the electrical connection board 20 is a light-guiding structure.

As described above, the housing 10 according to the present invention has the accommodating space 110 and the opening 120 communicating with the accommodating space 110. The electrical connection board 20 is disposed in the accommodating space 110. The plurality of USB signal terminals 210 are disposed on the electrical connection board 20 and provided for connecting electrically with the USB plug 2. Besides, the electrical connection board 20 is a light-guiding structure. The light-emitting unit 30 is disposed on one side of the electrical connection board 20.

Moreover, the housing 10, the electrical connection board 20, and the light-emitting unit 30 are disposed on the same circuit board 40. The light-emitting unit 30 is disposed on the same side of the housing 10 and the electrical connection board 20. The opening 120 of the housing 10 is disposed at the front end of the circuit board 40. The light-emitting unit 30 is disposed at the rear end of the circuit board 40. The plurality of USB signal terminals 210 of the electrical connection board 20 in the housing 10 are also connected electrically to the circuit board 40. In addition, the circuit board 40 is further connected to a control circuit 50. By using the rectifying circuit, the transformer circuit and the microcontroller circuit in the control circuit 50, the functions of charging between multimedia electronic devices or data transmission between electronic devices can be performed.

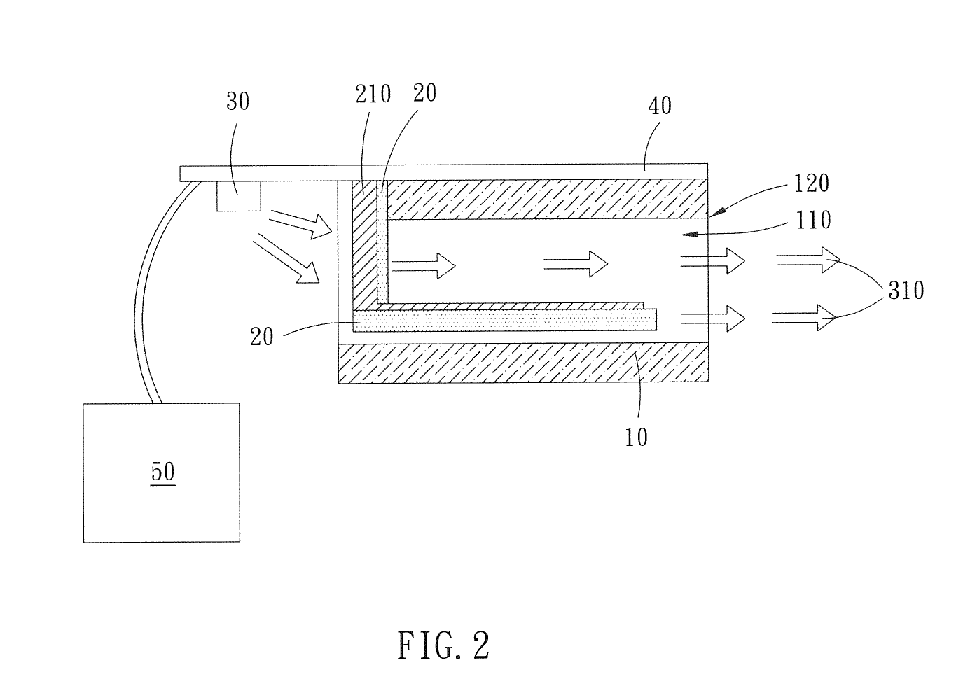

Please refer to FIG. 2, which shows a cross-sectional view of the light-emitting USB socket according to the first embodiment of the present invention. As shown in the figure, according to the present invention, the electrical connection board 20 is a light-guiding structure and the light-emitting unit 30 is disposed on one side of the electrical connection board 20. When the light-emitting unit 30 emitted light 310, the light 310 of the light-emitting unit 30 passes through the light-guiding electrical connection board 20. Then the light 310 propagates towards the direction of the opening 120 of the housing 10. Consequently, the light 310 can be seen from the opening 110 of the housing 10. Besides, the light-emitting unit 30 is a light-emitting diode chip. The color of the light emitted by the light-emitting diode chip can be adjusted according to the user's requirement.

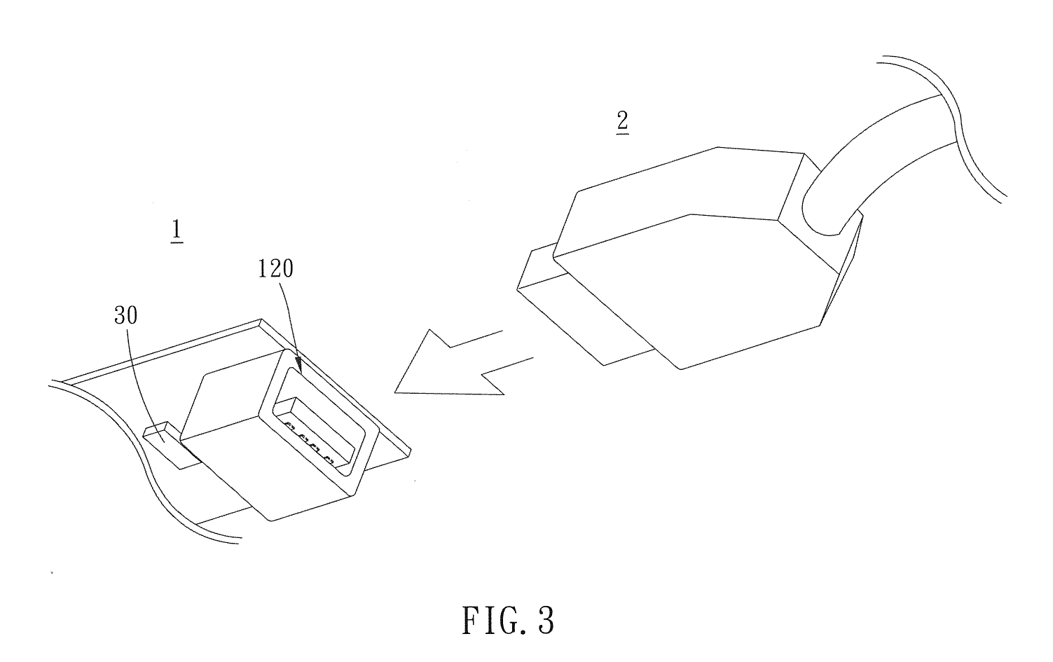

Please refer to FIG. 3, which shows a usage diagram of the light-emitting USB socket according to the first embodiment of the present invention. As shown in the figure, the USB socket 1 according to the present invention is used for mating the USB plug 2. The user can see the light 310 from the opening 110 of the USB socket 1. The USB socket 1 is a microstructure. When the light insufficient, it is not easy to insert the USB plug 2 into the USB socket 1. Thereby, the light 310 emitted by the USB socket 1 according to the present invention facilitates insertion of the USB plug 2.

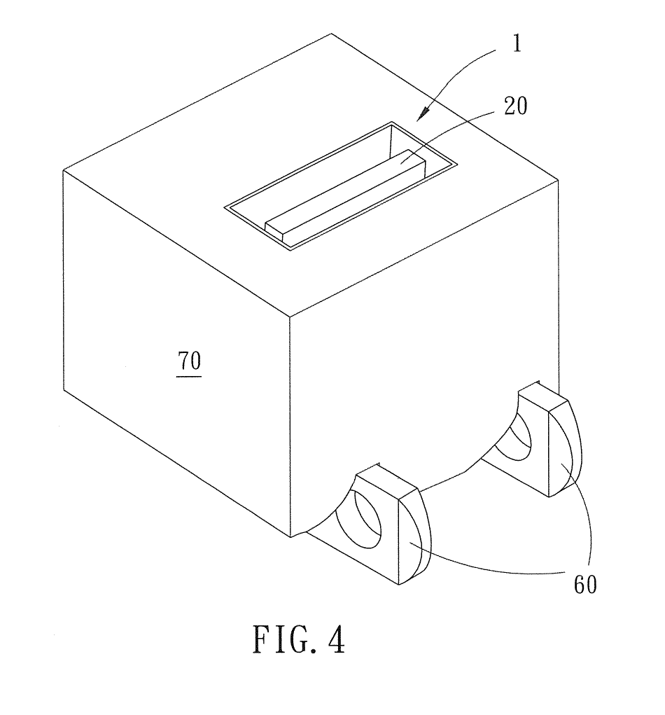

Please refer to FIGS. 2 to 4, where FIG. 4 shows a structural diagram of the object of the light-emitting USB socket according to the first embodiment of the present invention. As shown in the figures, then present invention further comprises a plug 60 connected electrically to the control circuit 50 (not shown in the figure). The plug 60 plugs to the external charging power supply, which inputs AC/DC power to the control circuit 50 via the plug 60. The external AC/DC power is converted to the charging current with the predetermined voltage by using the rectifying circuit, the transformer circuit, and the microcontroller circuit inside the control circuit 50. Then the control circuit 50 transfers the rectified and transformed charging current to the circuit board 40. The circuit board 40 is connected electrically with the plurality of USB signal terminals 210 on the electrical connection board 20. The USB socket 1 is inserted by the USB plug 2. Hence, power transfer is achieved by the electrical connection between the plurality of USB signal terminals 210 and the USB plug 2. Besides, a case 70 covers the whole structure for protecting the devices of the internal circuit. Thereby, electronic devices can be charged according to the above method. The electronic devices can be those capable of being charged using the USB interface, including MP3, iPod, PDA, mobile phones, and potable hard disks.

To sum up, the present invention provides a light-emitting USB socket 1 used for mating a USB plug 2 and comprises a housing 10, an electrical connection board 20, and at least a light-emitting unit 30. The housing 10 has an accommodating space 110 and an opening 120 communicating with the accommodating space 110. The electrical connection board 20 is disposed in the accommodating space 110. A plurality of USB signal terminals 210 are disposed on the electrical connection board 20 and provide electrical connection for the USB plug 2. In addition, the electrical connection board 20 is a light-guiding structure. The light-emitting unit 30 is disposed on one side of the electrical connection board 20. When the light-emitting unit 30 emitted light 310, the light 310 passes through the electrical connection board 20 and illuminates towards the direction of the opening 120 of the USB socket 1. Thereby, the USB plug 2 can mate the USB socket 1 accurately.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A light-emitting universal serial bus socket, applied to mating a universal serial bus plug, comprising:
a housing, having an accommodating space, and having an opening communicating with said accommodating space;
an electrical connection board, disposed in said accommodating space, having a plurality of universal serial bus signal terminals thereon for connecting electrically with said universal serial bus plug, and serving as a light-guiding structure; and
at least a light-emitting unit, disposed on one side of said electrical connection board, emitting light, and said light passing through said electrical connection board and illuminating towards the direction of said opening.

2. The light-emitting universal serial bus socket of claim 1, wherein said light-emitting unit is a light-emitting diode chip.

3. The light-emitting universal serial bus socket of claim 1, and further comprising a circuit board carrying said housing, said electrical connection board, and said light-emitting unit.

4. The light-emitting universal serial bus socket of claim 3, wherein said plurality of universal serial bus signal terminals are connected electrically to said circuit board.

5. The light-emitting universal serial bus socket of claim 3, and further comprising a control circuit connected electrically to said circuit board.

6. The light-emitting universal serial bus socket of claim 5, wherein said control circuit includes a rectifying circuit, a transformer circuit, and a microcontroller circuit.

7. The light-emitting universal serial bus socket of claim 5, and further comprising a plug connected electrically to said control circuit.
